(19) United States
(12) Patent Application Publication
(10) Pub. No.: US 2016/0259790 A1
(43) Pub. Date: Sep. 8, 2016

(54) Ranking External Content Using Social Signals on Online Social Networks

(71) Applicant: Facebook, Inc., Menlo Park, CA (US)

(72) Inventors: Li-Tal Mashiach, Redmond, WA (US); Michael Yehuda Rothschild, Sunnyvale, CA (US); Ethan Charles Stock, Belmont, CA (US); Soren Bogh Lassen, San Francisco, CA (US); Mohit Talwar, Redmond, WA (US)

(21) Appl. No.: 14/640,461

(22) Filed: Mar. 6, 2015

(51) Int. Cl. G06F 17/30

(52) U.S. Cl. CPC G06F 17/3053; G06F 17/30867

(57) ABSTRACT

In one embodiment, a method includes receiving a query to search for posts of the online social network; searching an index to identify one or more posts of the online social network that match the query, each post linking to an external object hosted by a third-party system, wherein the index includes a counter that records a number of social signals associated with each external object within the online social network; scoring each of the identified posts based at least in part on the counter associated with the external object linked to the post; and sending, to the client system of the first user, a search-results page including one or more search results, each search result including a reference to an identified post having a score greater than a threshold score.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may, in response to a query to search for posts of an online social network, search an index to identify one or more posts that match the query. Each of the one or more posts may link to an external object (e.g., a webpage, image, video, etc.) hosted by a third-party system. The index may include a counter that records a number of social signals (e.g., likes, comments, reshares, click-thrus, etc.) associated with each external object within the online social network. For example, the index may be a post index (a forward index) or a web index (an inverted index). The social-networking system may search the index to identify one or more posts that match the query by identifying one or more posts linking to one or more external objects based on matching one or more n-grams of the search query with one or more keywords associated with each post. The social-networking system may also score each of the identified post based at least in part on the counter associated with the external object linked to the post. The social-networking system may then generate search results including a reference to an identified post having a score greater than a threshold score. The generated search-results page including one or more search results that may then be displayed to a user.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example of a list of posts each linking to an external object on a third-part website that is displayed on a search-results page based on a search input.

FIG. 4 illustrates an example of a list of trending topics displayed on a newsfeed page.

FIG. 5 illustrates an example of a list of posts each linking to an external object on a third-part website that is displayed on a search-results page based on a selection of one of the listed trending topics.

FIGS. 6A and 6B illustrate examples of a post index and a web index, respectively.

FIG. 7 illustrates an example method for identifying posts linking to external objects based on social signals.

FIG. 7 illustrates an example method 700 for searching and ranking external webpages using a search index enhanced by internal social-networking content.

FIG. 8 illustrates an example computer system.

### DESCRIPTION OF EXAMPLE EMBODIMENTS

### System Overview

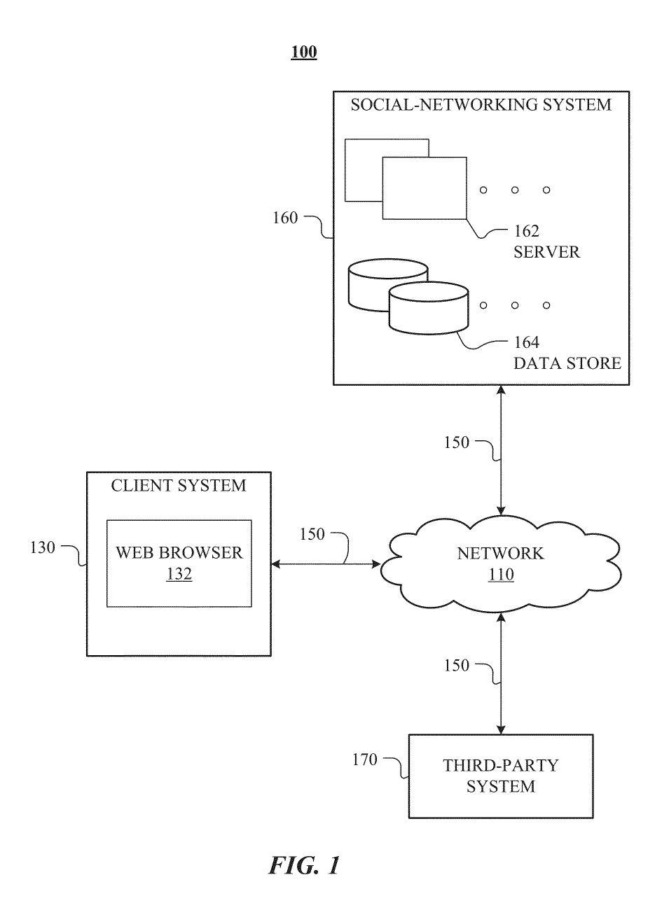

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser 132, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

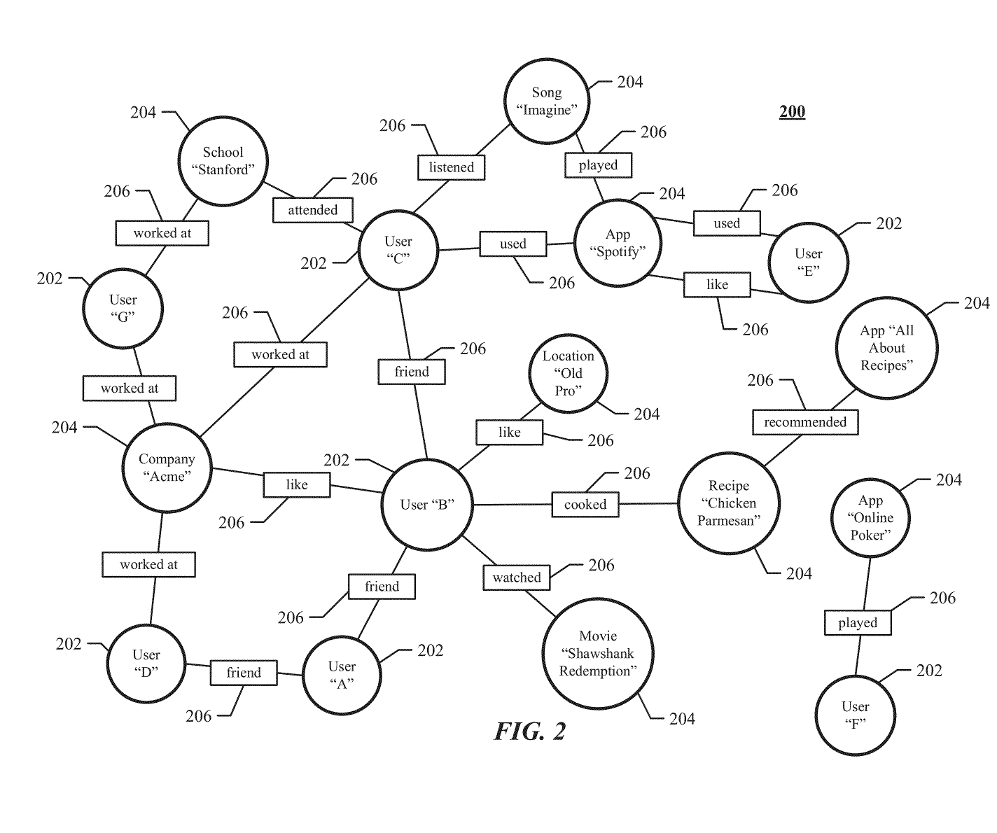

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, a user may submit a query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile pages, content-profile pages, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile pages, external webpages, or any combination thereof. The social-networking system 160 may then generate a search-results page with search results corresponding to the identified content and send the search-results page to the user. The search results may be presented to the user, often in the form of a list of links on the search-results page, each link being associated with a different page that contains some of the identified resources or content. In particular embodiments, each link in the search results may be in the form of a Uniform Resource Locator (URL) that specifies where the corresponding page is located and the mechanism for retrieving it. The social-networking system 160 may then send the search-results page to the web browser 132 on the user's client system 130. The user may then click on the URL links or otherwise select the content from the search-results page to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested page (such as, for example, a user-profile page, a concept-profile page, a search-results page, a user interface of a native application associated with the online social network, or another suitable page of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile pages and respective user nodes 202 or concept nodes 204, such as a profile page named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763,162, filed 19 Apr. 2010, and U.S. patent application Ser. No. 13/556,072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile pages and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, and U.S. patent application Ser. No. 12/978,265, filed 23 Dec. 2010, which are incorporated by reference.

Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556,072, filed 23 Jul. 2012, U.S. patent application Ser. No. 13/731,866, filed 31 Dec. 2012, and U.S. patent application Ser. No. 13/732,101, filed 31 Dec. 2012, each of which is incorporated by reference. More information on structured search queries and grammar models may be found in U.S. patent application Ser. No. 13/556,072, filed 23 Jul. 2012, U.S. patent application Ser. No. 13/674,695, filed 12 Nov. 2012, and U.S. patent application Ser. No. 13/731,866, filed 31 Dec. 2012, each of which is incorporated by reference.

Generating Keywords and Keyword Queries

In particular embodiments, social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244,748, filed 3 Apr. 2014, U.S. patent application Ser. No. 14/470,607, filed 27 Aug. 2014, and U.S. patent application Ser. No. 14/561,418, filed 5 Dec. 2014, each of which is incorporated by reference.

Search and Ranking Posts Linking to External Content Based on Social Signals

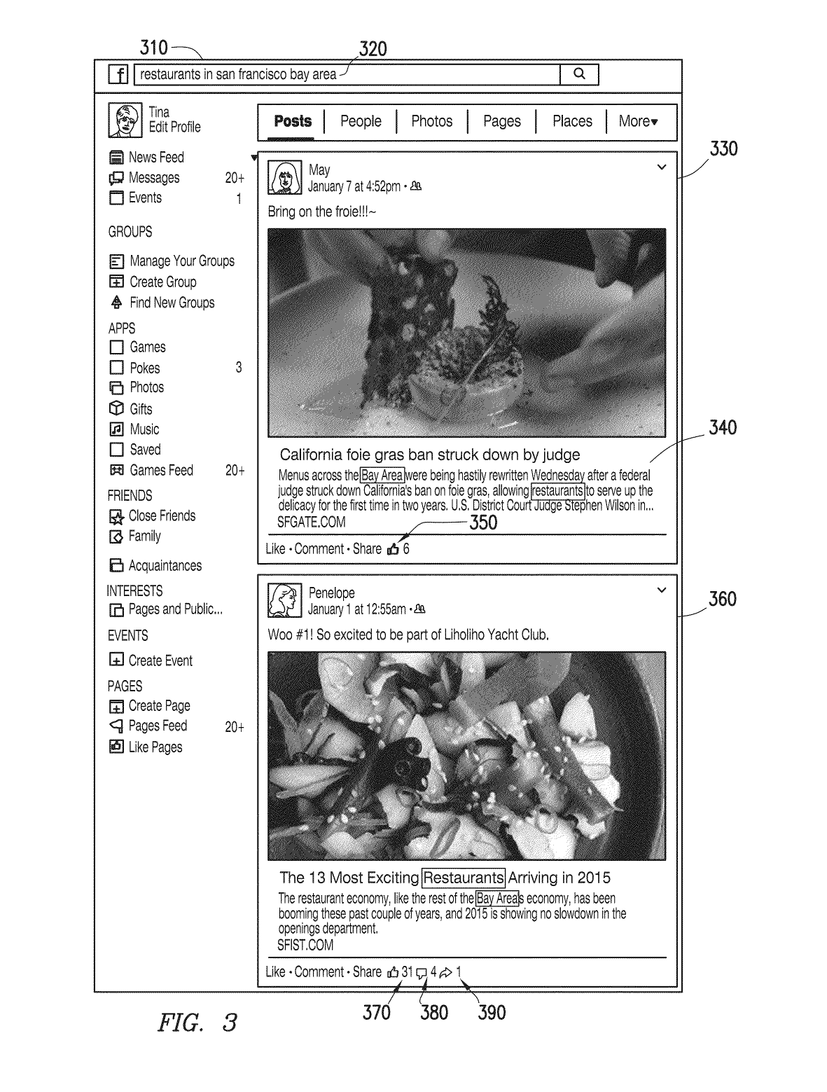

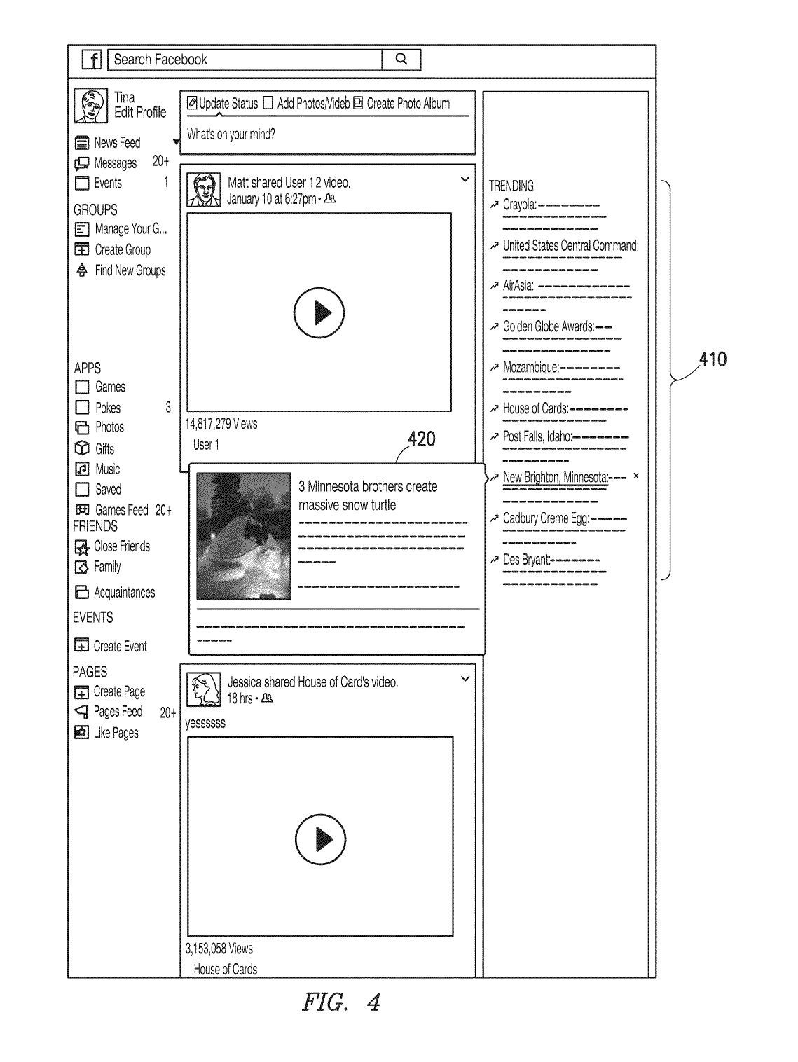

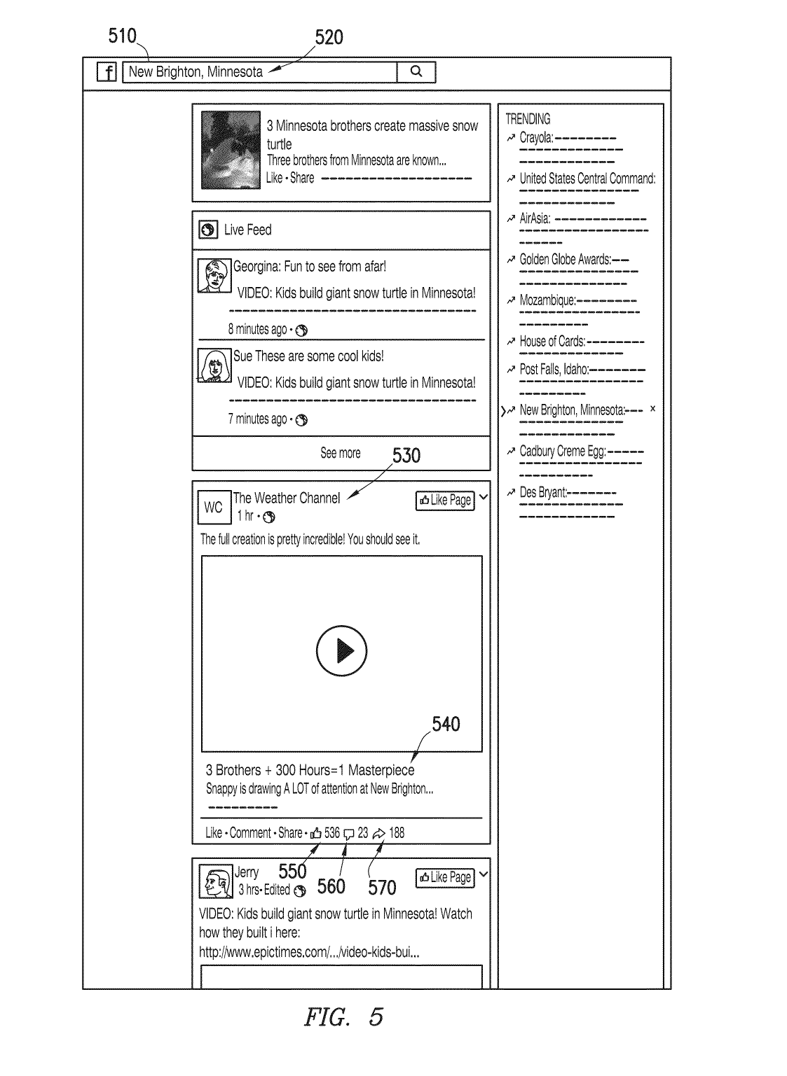

FIG. 3 illustrates an example of a list of posts each linking to an external object on a third-part website that is displayed on a search-results page based on a search input. FIG. 4 illustrates an example of a list of trending topics displayed on a newsfeed page. FIG. 5 illustrates an example of a list of posts each linking to an external object on a third-part website that is displayed on a search-results page based on a selection of one of the listed trending topics. When a user posts a link to an external object (e.g., a third-party webpage, multimedia object, etc.) on the online social network, other users of the online social network may view and interact with the post (e.g., other users may “like” a post, comment on a post, reshare a post, click-thru a link within a post, or other suitable interactions with the post on the online social network), which may be monitored and recorded as “social signals” by social-networking 160. The recording of these social signals may provide the online social network with internal social-networking content/information associated with the post by providing a measure of the number of user interactions with the post. The social-networking system 160 may then index these posts, and each post may be indexed with the types and numbers of their respective social signals so that a user's search for posts on the online social network may allow the social-networking system 160 to utilize a search index that is enhanced by the recorded social signals measuring the number of user interactions with a post. After receiving a query from a user to search for posts linking to external content associated with a keyword or phrase, the online social network can determine and present the user with the most relevant and suitable search results/posts from among those visible to the user (e.g., publically shared posts and posts by other users with a certain degree of affinity with the user) based on the social signals associated with the posts (e.g., information on the number of likes, reshares, and comments associated with a post), in addition to information received by the online social network through social plug-ins associated with the external content. In particular, the online social network may generate a search index of posts that includes both local total (e.g., social signals for a particular external object for a particular post) and global totals (e.g., social signals for a particular external object across all posts of the online social network) calculated for the relevant social signals associated with each particular external content result. Although this disclosure describes using this functionality in both the post search context (i.e., to identify the best posts matching a query) and in the trending topics context (i.e., to identify the best posts matching a selected topic), this disclosure contemplates using this functionality in any suitable context. Furthermore, although this disclosure focuses on search queries that are keyword search queries and topic search queries, this disclosure contemplates search queries of any suitable type (e.g., structured search queries, as disclosed in U.S. Pat. No. 8,732,208, which is incorporated by reference herein). The term “post” as used herein may include a publication by a user on an online social network, where a post may contain a link to external content hosted by a third party. The term “reshare” as used herein may include a publication by a user on an online social network, where the reshare may contain a link to external content hosted by a third party, and where the publication references another publication on the online social network (where the other publication may contain the link to the external content, for example, a post linking to external content may be linked to or embedded in the reshare). Although this disclosure describes identifying particular objects based on a search query in a particular manner, this disclosure contemplates identifying any suitable objects in any suitable manner.

In particular embodiments, the social-networking 160 may receive a search query to search for posts of an online social network from a client system 130 of a user of the online social network. In particular embodiments, the search query may include one or more n-grams. As an example and not by way of limitation, as shown in FIG. 3, a search query 310 may be typed by the user into a search field 320 on a page of the online social network. The social-networking system 160 may receive the search query 310 upon a confirmation input by the user (e.g., the pressing of the enter key, the clicking of a “search” button, or other suitable confirmation input). Alternatively, the social-networking system 160 may automatically receive the search query 310 in real-time as the user types text in a search field without the need for any further confirmation input from the user. As an example and not by way of limitation, the social-networking system 160 may receive multiple search queries as a user types “restaurants in san francisco bay area” into a search field. For example, when the user finishes typing “restaurants,” the social-networking system 160 may receive a search query including the text “restaurants”; when the user finishes typing “restaurants in san,” the social-networking system 160 may receive a search query including the test “restaurants in san”; when the user finishes typing “restaurants in san francisco,” the social-networking system 160 may receive a search query including the text “restaurants in san francisco”; when the user finishes typing “restaurants in san francisco bay,” the social-networking system 160 may receive a search query including the text “restaurants in san francisco bay”; and when the user finishes typing “restaurants in san francisco bay area,” the social-networking system 160 may receive a search query including the text “restaurants in san francisco bay area.” In other words, a user's partial query input may be processed using a typeahead process as the user inputs additional characters. In particular embodiments, before the user finishes typing a search query, the social-networking system 160 may generate keyword completion suggestions as search queries. As an example and not by way of limitation, when the user finishes typing “restaurants in san,” the social-networking system 160 may receive search queries for “restaurants in san francisco” and “restaurants in san jose” (where the text in bold indicates the keyword suggestions appended to the user's initial text input). In particular embodiments, the social-networking system 160 may receive a keyword search query from a user (e.g., a search query that includes distinct n-grams that are to be searched for). For example, a user may enter into a search field the text “restaurants in san francisco bay area,” which may include the following n-grams: “restaurants,” “restaurants in san francisco,” “san francisco,” “san francisco bay area,” and restaurants in san francisco bay area.” In particular embodiments, the social-networking system 160 may receive a structured query. As an example and not by way of limitation, in response to a user inputting the unstructured text query “restaurants in san francisco bay area,” the social-networking system 160 may parse the text query and generate one or more structured queries, such as, for example, “Posts by my friends about restaurants in San Francisco Bay Area” or “News about restaurants in San Francisco Bay Area,” where the structured queries may include references to particular social-graph elements. The structured query may be sent to the user as one or more suggested queries, which may then be selected or confirmed by the user. Although this disclosure describes receiving particular queries in a particular manner, this disclosure contemplates receiving any suitable queries in any suitable manner.

In particular embodiments, the search query may include one or more topics, as shown in FIGS. 4 and 5. As an example and not by way of limitation, a list of topics 410 may be presented to the user on a user interface of the social-networking system 160 (FIG. 4). For example, the list of topics 410 may include a list of “trending” topics related to particular people, places, events, or other topics that have exhibited upticks in activity on the social-networking system 160 such that the social-networking system 160 may create a trending-topics object 420 (e.g., a “trending” topic entry in the list of topics 410) corresponding to each of these topics. Each topic may refer to a title, description, name, or any other suitable descriptor or identifier corresponding to a particular event or subject matter. As an example and not by way of limitation, a topic may refer to any suitable event or any suitable subject matter, such as for example, a news event (e.g., the Presidential State of the Union address in January 2015), a political event (e.g., the 2016 United States presidential election), a sporting event (e.g., the 2015 Super Bowl), an organization (e.g., the Nobel Peace Prize nominating committee), a place (e.g., Yosemite National Park), a person (e.g., Barak Obama), a product (e.g., iPhone 6), a restaurant (e.g., Sancho's Taqueria), or any other type of suitable event or subject matter. As shown in FIGS. 4 and 5, a user may select a specific trending-topics object 420 corresponding to a topic with descriptor “New Brighton, Minn.” that references an news article titled “3 Minnesota brothers create massive snow turtle.” When the trending-topics object 420 is selected by the user, the social-networking system 160 may automatically receive the search query “New Brighton, Minn.” associated with the trending-topics object 420 to search for post of the online social network associated with the search query. More information on aggregating news events into topics for user selection on online social networks may be found in U.S. patent application Ser. No. 14/616,155, filed Feb. 6, 2015, which is incorporated by reference. Although this disclosure describes receiving particular search queries to search for particular objects in particular manners, this disclosure contemplates receiving any suitable search query to search for any suitable objects in any suitable manner.

In particular embodiments, a post may include a link to an external object hosted by the third-party system 170. As an example and not by way of limitation, the external object may be a webpage (e.g., a local newspaper website), a multimedia object (e.g., a YouTube link, an image, etc.) hosted by the third-party system 170, or other suitable content objects hosted on one or more third-party systems 170. For example, as shown in FIG. 3, a search query 320 of “restaurants in san francisco bay area” may result in a post by a user 330 (“May”) with a link to an article 340 hosted on the webpage SFGATE.com (i.e., an external object) titled “California foie gras ban struck down by judge.” In addition, for example, as shown in FIG. 5, a search query 520 of the topic of “New Brighton, Minn.” may result in a post by a user 530 (“the Weather Channel”) with a link to a video 540 (i.e., an external object) titled “3 Brothers+300 Hours=1 Masterpiece.” In particular embodiments, the link to the external object may include a uniform resource locator (URL) to the location of the external object on the World Wide Web. Although this disclosure describes specific examples of an external object that may be linked in a post, this disclosure contemplates any suitable external object that may be linked in a post of the social-networking system.

In particular embodiments, one or more social signals may be recorded based on a number and type of user interactions with objects associated with the external object. As an example and not by way of limitation, these user interactions recorded as social signals associated with each external object may include an indication of a post of the one or more posts linking to the external object, wherein the post may include one or more of an original post linking to the external object, a comment on a post linking to the external object, a reshare of a post linking to the external object, other suitable user interactions with objects associated with the external object, or any combination thereof. For example, referencing FIG. 5, user interactions recorded as social signals associated with the original post 530 may include the posting by a user of an original post (i.e., the original post 530 posted by the user “the Weather Channel”) linking to the video 540 titled “3 Brothers+300 Hours=1 Masterpiece”; the posting by a user of one or more comments 560 (i.e., 23 total comments) associated with the original post 530; and the posting by a user of one or more reshares 570 (i.e., 186 total reshares) of the original post 530. In addition, user interactions recorded as social signals associated with the original post 530 may include an accessing or viewing, by a user, of the original post, the comment, or the reshare linking to the external object. For example, referencing FIG. 5, user interactions recorded as social signals associated with the original post 530 may also include accessing and/or viewing the original post 530 itself, the comments 560 (i.e., any of the 23 total comments) associated with the original post 530, or the reshares 570 (i.e., accessing and/or viewing of any of the 186 reshares) of the original post 530 posted by other users. Moreover, user interactions recorded as social signals associated with the original post 530 may include a “like” indication of the original post 530 or any of the one or more reshares 570 linking to the original post 530, in addition to a “like” indication of any of the comments associated with the original post 530 or any of the one or more reshares 570 linking to the original post 530. For example, referencing FIG. 5, user interactions recorded as social signals associated with the original post 530 may also include the “like” indication 550 (i.e., 536 total “likes”) associated with the original post 530, in addition to any “like” indications that may be associated with any of the comments 560 or the reshares 570 of the original post 530. In addition, user interactions recorded as social signals associated with the original post 530 may include a click-thru of a link to the external object in the original post, the comment, or the reshare of the original post linking to the external object. For example, referencing FIG. 5, user interactions recorded as social signals associated with the original post 530 may also include a number of click-thrus (i.e., the number of times a user clicks on the link to the video 540 of the original post 530) associated with the original post 530, the comments 560 associated with the original post 530, or the reshares 570 of the original post 530 linking to the video. Moreover, user interactions recorded as social signals associated with the original post 530 may include any combination thereof of the above-discussed social signals. Although this disclosure describes receiving particular social signals in particular manners, this disclosure contemplates receiving any suitable social signals in any suitable manner.

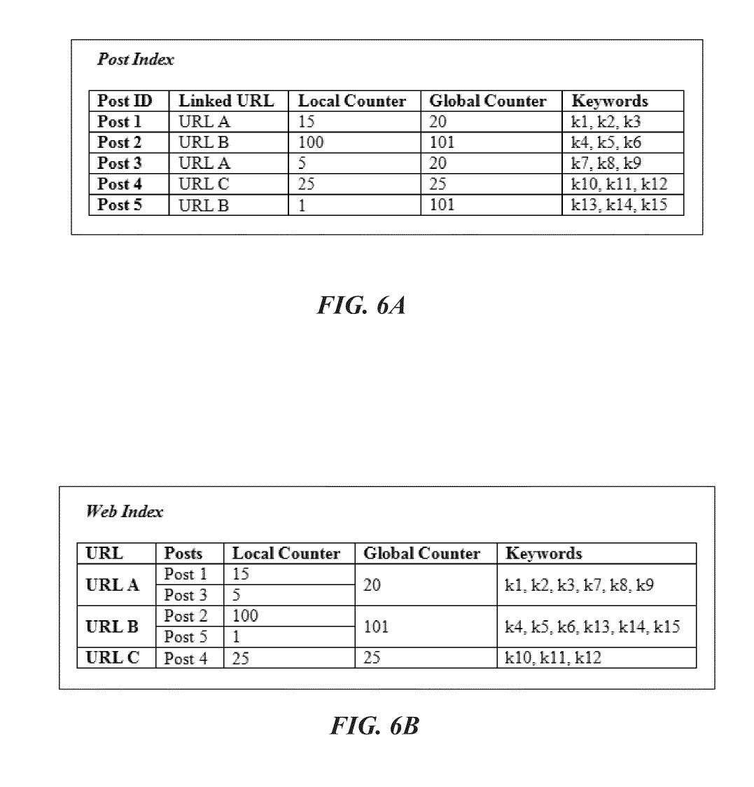

FIG. 6A illustrates an example of a post index. In particular embodiments, the index may be a post index (a forward index) that maps a post with a number and type of user interactions recorded as social signals associated with the post and/or the external object linked in the post. Generally, a forward index for a first object-type (e.g., a post or reshare) may include a list of search indices listed corresponding to the first object-type. As shown in FIG. 6A, the forward index for the first object-type may map a query term (e.g., a keyword) associated with the first object-type to one or more objects of a second object-type (e.g., a number and type of user interactions recorded as social signals associated with the post and/or the external object linked in a post or reshare). The social-networking system 160 may extract one or more keywords from a post or reshare. As an example and not by way of limitation, as shown in FIG. 6A, keywords k1, k2, and k3 are associated with Post 1; keywords k4, k5, and k6 are associated with Post 2; keywords k7, k8, and k9 are associated with Post 3; keywords k10, k11, and k12 are associated with Post 4; and keywords k13, k14, and k15 are associated with Post 5. The social-networking system 160 may then index the post or reshare by a first column of a post ID (i.e., a unique ID generated by the social-networking system 160 corresponding to a particular post or reshare, such as Post 1, Post 2, Post 3, Post 4, or Post 5) as an index entry of the post index. In other words, every time a user uploads a post or reshare that includes a link to an external object hosted by the third-party system, an identifier (i.e., the post ID) linked to the post and/or all post content will be uploaded to the post index. As an example and not by way of limitation, each index entry may store the URL linked in the post (e.g, URL A, URL B, and URL C). In addition, each post or reshare may include metadata associated with the external object linked in the post or reshare, and the metadata may comprise information associated with the external object. The metadata may also include information on the external webpage, including the domain name associated with the webpage, the author of the webpage, and any information on one or more updates to the webpage, domain, and/or the author.

In particular embodiments, the post index entries may include post counters that record the number of times each type of user interaction monitored and recorded as a social signal is received/recorded for the post or reshare. In particular embodiments, one or more of these post counters may be recorded in the post index. As an example and not by way of limitation, one of the post counters may be a local counter that records the number of likes, comments, shares, click-thrus, or other suitable interactions associated with each URL for each particular post or reshare. For example, as shown in FIG. 6A, Post 1 may include a link to URL A with an associated local counter that indicates that 15 social signals have been recorded for Post 1 linking to URL A; Post 2 may include a link to URL B with an associated local counter that indicates that 100 social signals have been recorded for Post 2 linking to URL B; Post 3 may include a link to URL A (i.e., same URL as in Post 1) with an associated local counter that indicates that 5 social signals have been recorded for Post 3 linking to URL A; Post 4 may include a link to URL C with an associated local counter that indicates that 25 social signals have been recorded for Post 4 linking to URL C; and Post 5 may include a link to URL B (i.e., same URL as in Post 2) with an associated local counter that indicates that 1 social signal has been recorded for Post 5 linking to URL B. In particular embodiments, one URL may be linked in multiple posts or reshares. As shown in FIG. 6A, URL A is linked in Post 1 and Post 3, and URL B is linked in Post 2 and Post 5. In these situations, the post index may maintain global counters for each linked URL in a post based on a count of the number of times each social signal is received across all posts in the online social network that link to the same URL. As an example and not by way of limitation, as shown in FIG. 6A, because URL A is linked in both Post 1 and Post 3, with the local counter of Post 1 recording 15 social signals and the local counter of Post 3 recording 5 social signals, the global counters associated with both Post 1 and Post 3 each shows a total of 20 social signals (15 from Post 1+5 from Post 2). In addition, because URL B is linked in both Post 2 and Post 5, with the local counter of Post 2 recording 100 social signals and the local counter of Post 5 recording 1 social signal, the global counters associated with both Post 2 and Post 5 each shows a total of 101 social signals (100 from Post 2+1 from Post 5). In particular embodiments, the local and/or global counters may include separate counters for each social signal. As an example and not by way of limitation, the local and/or global counters may include a first counter that records a number of comments received for either the external object linked in a particular post (e.g., a local counter), or alternatively, all posts (e.g., a global counter) that comprise the link to the external object; a second counter that records a number of reshares for either the external object linked in a particular post (e.g., a local counter), or alternatively, all posts (e.g., a global counter) that comprise the link to the external object; a third counter that records a number of likes received for either the external object linked in a particular post (e.g., a local counter), or alternatively, all posts (e.g., a global counter) that comprise the link to the external object; a fourth counter that records a number of click-thrus of a link corresponding to the external object linked in a particular post (e.g., a local counter), or alternatively, all posts (e.g., a global counter) that comprise the link to the external object, the comments, or the reshares linking to the external object; or any combination thereof. In particular embodiments, for a particular URL, when user interaction monitored and recorded as a new social signal is received for a post or reshare linking to that URL (e.g., a new “like” indication is received for the post or reshare), the social-networking system 160 may update the post index by updating the local post counter associated with that particular post or reshare. In addition, the social-networking system 160 may determine whether the URL is associated with at least one other post or reshare on the online social network, and, if it is determined that the URL is associated with at least one other post or reshare, the social-networking system 160 may also update the global counter(s) for any of these other post(s) or reshare(s) that also include a link to the same URL. Although this disclosure describes a particular type of index with particular index entries in a particular manner, this disclosure contemplates receiving any suitable index with any suitable number and type of index entries in any suitable manner.

FIG. 6B illustrates an example of a web index. In particular embodiments, the search index may be a web index (an inverted index) that maps a URL linked in one or more posts with one or more user interactions monitored and recorded as one or more social signals associated with the URL. Generally, an inverted index for a first object-type (e.g., a post or reshare linking to a URL) may include a list of search indices listed corresponding to a second object-type (e.g., the URL), and may map a query term (e.g., a keyword) with one or more objects (e.g., user interactions recorded as social signals) associated with the second object-type. The post or reshare may be indexed by one or more post identifiers linking to each of one or more posts of the online social network that include the URL. The social-networking system 160 may extract one or more keywords from the post or reshare. As an example and not by way of limitation, as shown in FIG. 6B, keywords k1, k2, k3, k7, k8, and k9 are associated with URL A; keywords k4, k5, k6, k13, k14, and k15 are associated with URL B, and k10, k11, and k12 are associated with URL C. The social-networking system 160 may index, in a web index entry, a linked external object by a URL (or alternatively any generic page ID) from each external object. As an example and not by way of limitation, as shown in FIG. 6B, the first column of web index entries includes URL A, URL B, and URL C. Each index entry for each URL may store all posts and/or reshares that link to the URL. As shown in FIG. 6B, the web index stores Post 1 and Post 2 as linking to URL A, Post 2 and Post 5 as linking to URL B, and Post 3 as linking to URL C. In addition, each URL entry may include metadata associated with the external object linked by the URL in the post or reshare, and the metadata may comprise information associated with the external object. As discussed above, the metadata may also include information on the external webpage, including the domain name associated with the webpage, the author of the webpage, and any information on one or more updates to the webpage, domain, and/or the author.

In particular embodiments, the web index entries may also include web index counters that record the number of times each type of user interaction monitored and recorded as a social signal is received/recorded for each URL, the user interactions including the number of likes, comments, shares, click-thrus, or other suitable interactions associated with each external object linked by the URL. In particular embodiments, a local social signal counter associated with each post or reshare is indexed to record the number of user interactions monitored and recorded as social signals are received for a particular URL in each post or reshare, and a global social signal counter that determines a total number of user interactions monitored and recorded as social signals associated with each (unique) URL is indexed by determining a sum of all local counters associated with all of the one or more post and reshares linking to the URL. As shown in FIG. 6B, Post 1 may have an associated local counter that indicates that 15 socials signals have been recorded for URL A linked in Post 1, and Post 3 may have an associated local counter that indicates that 5 social signals have been recorded for the same URL A also linked in Post 3. Thus, the global counter associated with URL A indicates that a total of 20 social signals (15 social signals from Post 1+5 social signals from Post 3) have been recorded for URL A. In addition, Post 2 may have an associated local counter that indicates that 100 social signals have been recorded for URL B linked in Post 2, and Post 5 may have an associated local counter that indicates that 1 social signal has been recorded for the same URL B also linked in Post 5. Thus, the global counter associated with URL B indicates that a total of 101 social signals (100 social signals from Post 2+1 social signal from Post 5) have been recorded for URL B. Moreover, Post 4 may have an associated local counter that indicates that 25 social signals have been recorded for URL C linked in Post 4, and the social-networking system 160 determines that no other posts or reshares include a link to URL C. Thus, and the global social signal counter associated with URL C indicates that a total of 25 social signals have been recorded for URL C. In particular embodiments, the local and/or global counters may include separate counters for each social signal. As an example and not by way of limitation, as discussed above, the local and/or global counters may include a first local or global counter that records a number of comments received for the external object linked in a post; a second local or global counter that records a number of reshares for the external object linked in a post that comprises the link to the external object; a third local or global counter that records a number of likes received for the external object linked in a post that comprises the link to the external object; a fourth local or global counter that records a number of click-thrus of a link corresponding to the external object linked in a post that comprises the link to the external object, the comments, or the reshares linking to the external object; or any combination thereof. In particular embodiments, when a new user interaction monitored and recorded as a new social signal (e.g., a newly received “like” indication) is received for a particular post or reshare linking to a particular URL, the social-networking system 160 may update the web index by updating the local counter associated with the particular post or reshare associated with the particular URL, and may also update the global counter associated with the particular URL based on the updated local counter to record the total number of user interactions monitored and recorded as social signals associated with the URL in all posts or reshares that include a link to the URL. Although this disclosure describes a particular type of index with particular index entries in a particular manner, this disclosure contemplates receiving any suitable index with any suitable number and type of index entries in any suitable manner.

In particular embodiments, the social-networking system 160 may search an index to identify one or more posts of the online social network that match the inputted search query. The index may be a post index or a web index, as discussed above. The index may include a plurality of entries of the one or more posts indexed with one or more keywords associated with each of the one or more posts. For example, the keywords may be extracted from the one or more posts, reshares of the one or more posts, or comments associated with the external objects linked in the one or more posts. In particular embodiments, when the query comprises the one or more n-grams (as discussed above), the search of the index includes identifying one or more posts of the online social network that match the one or more n-grams of the query. As an example and not by way of limitation, a search input of “restaurants in san francisco bay area” may result in the searching for keywords including “restaurants,” “san francisco”, and “bay area.” Thus, as shown in FIG. 3, this search input may result in a post including the link 340 linking to a webpage, titled “California foie gras ban struck down by judge,” that includes at least the keywords “Bay Area” and “restaurants” extracted from the associated post by user 330. In particular embodiments, each identified post is indexed with one or more keywords matching the one or more n-grams. As an example and not by way of limitation, as shown in FIG. 3, the post by user 330 links to the webpage titled “California foie gras ban struck down by judge” includes at least the extracted keywords “Bay Area” and “restaurants” that matched two of the n-grams of the user query (as discussed above), and the post by user 360 link to a webpage titled “The 13 Most Exiting Restaurants Arriving in 2015” includes at least the extracted keywords “restaurants” and “Bay Area” that match two of the n-grams of the user query. In particular embodiments, the one or more keywords matching the one or more n-grams includes keywords that substantially match the n-grams of the search query, and this may include situations of misspellings, synonyms, abbreviations, and other potential errors and/or variations in user-inputted search queries. Alternatively, a speller functionality may normalize queries by identifying misspellings, synonyms, abbreviations, etc., and then n-grams from the normalized queries (e.g., spell-corrected queries) may then be used to identify posts that match the query. More information on spell correction and speller models may be found in U.S. patent application Ser. No. 14/556,368, filed 1 Dec. 2014, which is incorporated by reference. In particular embodiments, in searching the index, the social-networking system 160 may first access a plurality of entries of the index, and then identify one or more posts linking to one or more external objects based on matching the one or more n-grams of the search query with one or more keywords associated with each post (e.g., as illustrated in FIG. 3, as discussed above). In particular embodiments, when the search query includes one or more topics, searching the index includes searching the index to identify one or more posts of the online social network that are associated with the one or more topics of the query. As an example and not by way of limitation, as shown in FIGS. 4 and 5, a user selection of the trending-topics object 420 may result in a search input 520 of “New Brighton, Minn.,” resulting in a list of search results including a post by a user 530 (e.g., The Weather Channel) that includes a link to the video 540 titled “3 Brothers+300 Hours=1 Masterpiece” that matches the trending-topics object 420 selected by the user. Although this disclosure describes searching an index to identify posts of the online social network in a particular manner, this disclosure contemplates searching an index in any suitable manner.

In particular embodiments, the social-networking system 160 may score each of the identified posts based at least in part on the counter associated with the external object linked to the post. As discussed above, when the user inputs a search query for posts, the social-networking system 160 may access a search index to identify a plurality of search results matching the query. As an example and not by way of limitation, in the case where the search index is a post index, the search engine may identify a list of all posts matching the query (e.g., based on keywords associated with each post). Then, for each post, a score may be determined based at least in part on the local and/or global counters that record the number of user interactions monitored and recorded as social signals associated with the external object linked in the post. The score may be determined based on a cumulative total (or, alternatively, a weighted cumulative total) of the global counts for each of a plurality of user interactions monitored and recorded as global social signals received for the post. As an example and not by way of limitation, when the global counter includes a first global counter that records a total number of comments received for the external object linked in all posts that include the link to the external object, a second global counter that records a total number of reshares for the external object linked in all posts that include the link to the external object, a third counter that records a total number of likes received for the external object linked in all posts that include the link to the external object, and a fourth counter that records a total number of click-thrus of a link corresponding to the external object linked in all posts that include the link to the external object, the comments, or the reshares linking to the external object, the score for each post may be determined by calculating a weighted cumulative total of the first counter, the second counter, the third counter, and the fourth counter. In particular embodiments, posts may be ranked based on their respective scores, and this ranking model may be a linear function of some or all of the above-described counters and social signals. Once all the posts are ranked based on their respective scores, the most relevant posts determined based on the scores results may be presented to the user by sending, to a client system 130 of the user, a search-results page including one or more of the most relevant posts, where each of the relevant posts includes a reference to an identified post having a score greater than a threshold score. In particular embodiments, the search results of the search-results page may be presented in an order based on the scores of the identified posts corresponding to the search results. As an example and not by way of limitation, referencing FIG. 3, the social-networking system 160 may, in response to a user search query for “restaurants in san francisco bay area,” generate a search result with the news article “California foie gras ban struck down by judge” referenced by the link 340 (which may have a score greater than the threshold score), but not a search result with an external object (e.g., news article, video, image) about restaurants in New York City (which may have a score less than the threshold score). Although this disclosure describes calculating a particular score for a particular object in a particular manner, this disclosure contemplates employing any suitable scoring mechanism for any suitable object.

As an example and not by way of limitation, in the case where the search index is a web index, the search engine may identify webpages (with associated URLs) that match the query (e.g., based on keywords associated with each webpage, which may be extracted from posts about the webpage, blurbs for the webpage, etc.). The social-networking system 160 may then calculate a score for each URL based on a cumulative total (or a weighted cumulative total) of the counts for each of the user interactions monitored and recorded as global social signals recorded for a particular URL. As an example and not by way of limitation, when the global counter includes a first global counter that records a total number of comments received for the external object linked in all posts that include the link to the external object, a second global counter that records a total number of reshares for the external object linked in all posts that include the link to the external object, a third counter that records a total number of likes received for the external object linked in all posts that include the link to the external object, and a fourth counter that records a total number of click-thrus of a link corresponding to the external object linked in all posts that include the link to the external object, the comments, or the reshares linking to the external object, the score for each post may be determined by calculating a weighted cumulative total of the first counter, the second counter, the third counter, and the fourth counter. In particular embodiments, posts may be ranked based on their respective scores, and this ranking model may be a linear function of some or all of the above-described counters and social signals. Once the URLs are ranked based on their respective scores, the most relevant URLs may be determined, and posts that link to the high-ranking and relevant URLs can then be identified. Once the most relevant posts are identified, these posts may then be scored (e.g., based on a number of factors discussed below) and presented to the user as search results on a search-results page (e.g., by sending, to a client system 130 of the user, the search-results page including one or more of the most relevant posts), where each of the relevant posts includes a reference to an identified post having a score greater than a threshold score. In particular embodiments, the search results of the search-results page may be presented in an order based on the scores of the identified posts corresponding to the search results. Although this disclosure describes calculating a particular score for a particular object in a particular manner, this disclosure contemplates employing any suitable scoring mechanism for any suitable object.

In particular embodiment, the score for ranking relevant posts may be further determined based on a degree of separation and/or affinity within a social graph of the online social network between the user and an author of the identified post, as discussed in more detail below. In particular embodiments, the score of each of the identified posts may be determined based on a relationship within the online social network between the user inputting the search query and an author of a post or reshare corresponding to the identified post linking to the external object. The social-networking system 160 may access the social graphs to determine relationships among users within the online social network. As an example and not by way of limitation, the social-networking system 160 may calculate a higher score for an identified post or reshare by an author who is a first-degree friend of the user on the online social network. As another example and not by way of limitation, the social-networking system 160 may calculate an even higher object-score for a post or reshare by an author who is both a first-degree friend and a listed family member of the user or as a partner of the user (e.g., someone listed as being in a relationship with the user) on the online social network.

In particular embodiments, the score for ranking relevant posts may be further determined based on a quality of the match between the one or more n-grams of the search query and the one or more keywords associated with the identified post. As an example and not by way of limitation, the social-networking system 160 may calculate a higher score for a post in which all or most of the keywords associated with the post match the search query. In particular embodiments, the score for ranking relevant posts may be further determined based on accessing a second counter that records a number of activations of one or more social plug-ins of the online social network associated with a URL of the external object, each social plug-in activation indicating the webpage has been accessed by a user of the online social network, and wherein the scoring each of the identified posts is further based on a number of times the external object associated with the identified multimedia object has been accessed by users of the online social network. As an example and not by way of limitation, the social-networking system 160 may calculate a higher score for a post in which social plug-in counter records a predetermined threshold and/or number of activations associated with a URL of the external object. More information on measuring the number of activations of social plug-ins on online social networks may be found in U.S. patent application Ser. No. 14/533,229, filed 5 Nov. 2014, which is incorporated by reference. In particular embodiments, the score for ranking relevant posts may be further determined based on the first creation date of a post. As an example and not by way of limitation, the social-networking system 160 may calculate a higher score for posts including more time-sensitive (e.g., events starting or ending at a particular time and/or date close to a current date) and/or newer-dated materials and/or events (e.g., recently occurring articles/events or recently published article/events). In particular embodiments, the score for ranking relevant posts may be further determined based on user preferences for a particular web domain. As an example and not by way of limitation, the social-networking system 160 may determine that a user may have certain favorite or commonly-viewed web domains (e.g., nytimes.com, cnn.com), and thus may calculate a higher score for post including links to external objects that are located on these particular web domains. In particular embodiments, the score for ranking relevant posts may be further determined based on languages used/known by or of importance to the user. As an example and not by way of limitation, the social-networking system 160 may determine that a user is fluent in particular languages and thus calculates a higher score for posts including links to external objects that are available those languages. In particular embodiments, the score for ranking relevant posts may be further determined based on topics extracted from the article, related topics, and keywords associated with these topics. As an example and not by way of limitation, the social-networking system 160 may determine the topic(s), related topic(s), and keyword(s) associated with the topic(s) by reviewing and “scraping” the content of the external object linked in a post, and then calculate a higher score for posts with the topic(s), related topic(s), and/or keyword(s) associated with the topic(s) that match or substantially match the user's search query. In particular embodiments, the score for ranking relevant posts may be further determined based on content related to webpage and/or the author of the webpage. As an example and not by way of limitation, the social-networking system 160 may calculate a higher score when the content of a URL linked in a post or content related to the author of the URL content matches or substantially matches the user's query. In particular embodiments, the score for ranking relevant posts may be further determined based on the quality of a URL, the domain of the URL, and/or the author of the content of the URL. As an example and not by way of limitation, the social-networking system 160 may calculate a higher score for a URL, a domain of a URL, and/or an author of the content of a URL based on previously-collected data indicating that the URL, the domain, and/or the author provides high quality content, such as content that is interesting, reliable, trending, fresh, or appealing. More information on ranking domains by online social networks may be found in U.S. patent application Ser. No. 14/533,229, filed 5 Nov. 2014, which is incorporated by reference, and more information on detecting and ranking authors of content of URLs by online social networks may be found in U.S. patent application Ser. No. 14/554,190, filed 26 Nov. 2014, which is incorporated by reference. Although this disclosure describes particular factors for determining the ranking of relevant posts in a particular manner, this disclosure contemplates employing any suitable factors in any suitable manner in order to rank relevant posts.

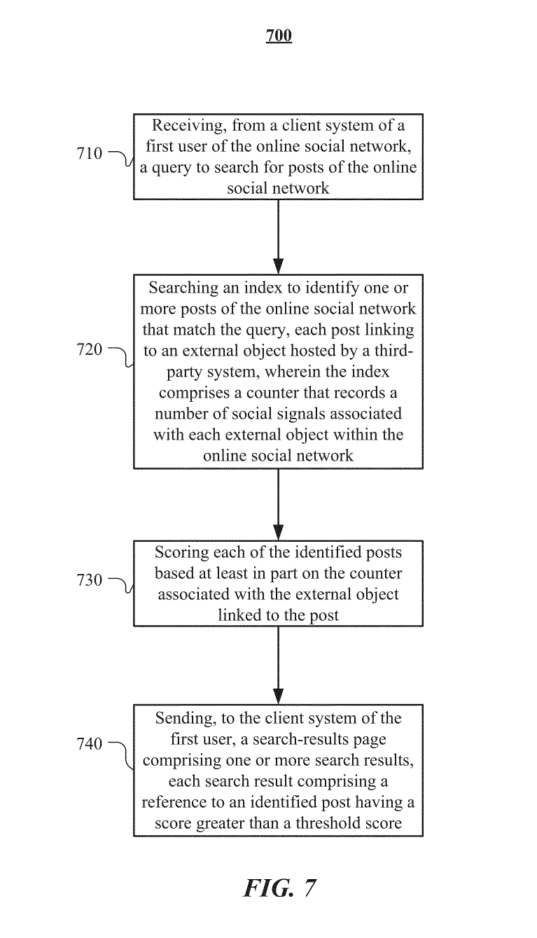

FIG. 7 illustrates an example method 700 for searching and ranking external webpages using a search index enhanced by internal social-networking content. The method may begin at step 710, where social-networking system 160 may receive, from a client system 130 of a first user of the online social network, a search query to search for posts of the online social network. The search query may include one or more n-grams. At step 720, social-networking system 160 may search an index to identify one or more posts of the online social network that match the query, each post linking to an external object hosted by a third-party system. The index may comprise a post index (a forward index) or a web index (an inverted index). The index may comprise a counter that records a number of user interactions monitored and recorded as social signals associated with each external object within the online social network. The external object may comprise a URL to a webpage, a video, an image, or other suitable external content. At step 730, social-networking system 160 may score each of the identified posts based at least in part on the counter associated with the external object linked to the post. At step 740, social-networking system 160 may send, to the client system 130 of the first user, a search-results page comprising one or more search results, each search result comprising a reference to an identified post having a score greater than a threshold score. The search results may be ranked based at least in part on the score of each of the identified posts, and the search results of one or more identified posts may be displayed based on the rank. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for searching and ranking external webpages using a search index enhanced by internal social-networking content including the particular steps of the method of FIG. 7, this disclosure contemplates any suitable method for searching and ranking external webpages using a search index enhanced by internal social-networking content including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

### Social Graph Affinity and Coefficient

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user may make frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Systems and Methods

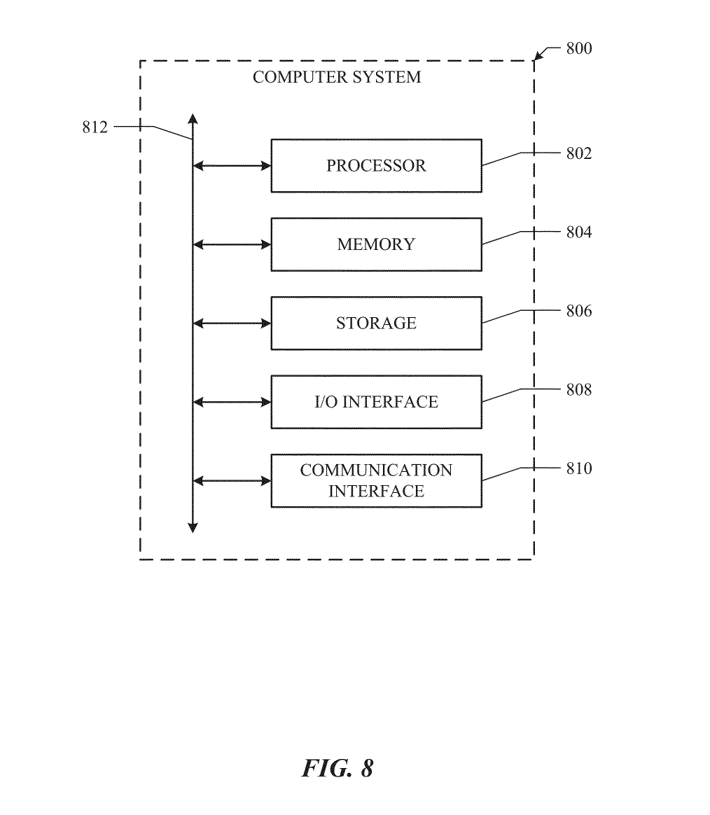

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more computing devices of an online social network:
receiving, from a client system of a first user of the online social network, a query to search for posts of the online social network;
searching an index to identify one or more posts of the online social network that match the query, each post linking to an external object hosted by a third-party system, wherein the index comprises a counter that records a number of social signals associated with each external object within the online social network;
scoring each of the identified posts based at least in part on the counter associated with the external object linked to the post; and
sending, to the client system of the first user, a search-results page comprising one or more search results, each search result comprising a reference to an identified post having a score greater than a threshold score.

2. The method of claim 1, wherein the query comprises one or more n-grams, and wherein searching the index to identify one or more posts of the online social network that match the query comprises searching the index to identify one or more posts of the online social network that match the one or more n-grams of the query.

3. The method of claim 2, wherein each identified post is indexed with one or more keywords matching the one or more n-grams.

4. The method of claim 1, wherein the query comprises a one or more topics, and wherein searching the index to identify one or more posts of the online social network that match the query comprises searching the index to identify one or more posts of the online social network that are associated with the one or more topics of the query.

5. The method of claim 1, further comprising:
accessing a social graph comprising a plurality of nodes and a plurality of edges connecting the nodes, each of the edges between two of the nodes representing a single degree of separation between them, the nodes comprising:
a first node corresponding to the first user;
a plurality of user nodes corresponding to a plurality of second users of the online social network, respectively; and
a plurality of content nodes corresponding to a plurality of posts of the online social network.

6. The method of claim 5, wherein each identified post is authored by a second user of the plurality of second users.

7. The method of claim 1, wherein searching the index to identify one or more posts that match the query comprises:
accessing the index, the index comprising a plurality of entries, and
identifying one or more posts linking to one or more external objects based on matching the one or more n-grams of the search query with one or more keywords associated with each post.

8. The method of claim 7, wherein the social signals associated with each external object comprise one or more of:
an indication of a post of the one or more posts linking to the external object, the post comprising one or more of:
an original post linking to the external object;
a comment on a post linking to the external object; and
a reshare of a post linking to the external object;
an accessing or viewing of the original post, the comment, or the reshare linking to the external object;
a like of the original post, the comment, or the reshare linking to the external object;
a click-thru of a link to the external object in the original post, the comment, or the reshare linking to the external object; or
any combination thereof.

9. The method of claim 8, wherein the index comprises a post index, the post index being a forward index, each entry of the index comprising:
a post ID corresponding to a particular post of the online social network;
a link to an external object hosted by the third-party system, the external object being linked in the particular post corresponding to the post ID of the entry of the index, the link being a uniform resource locator (URL) of the external object; and
metadata associated with the external object linked in the particular post corresponding to the post ID of the entry in the index, the metadata comprising information associated with the external object.

10. The method of claim 9, wherein each entry of the index further comprises the counter that records the number of social signals associated with the external object linked in the particular post corresponding to the post ID of the entry of the index, the counter comprising:
a global counter that records a total number of social signals associated with the URL for all posts of the one or more posts that comprise the URL; and
a local counter that records a number of social signals associated with each URL for a particular post of the one or more posts.

11. The method of claim 10, further comprising:
receiving an indication that a new social signal corresponding to the URL has been added to a particular post on the online social network,
updating the local counter associated with the URL for the particular post,
updating the global counter associated with the URL for the particular post,
determining whether the URL is associated with at least one other post on the online social network, and
when it is determined that the URL is associated with at least one other post, updating a global counter associated with the URL for the at least one other post.

12. The method of claim 8, wherein the index comprises a web index, the web index being an inverted index, each entry of the index comprising:
a URL of an external object hosted by the third-party system;
one or more post identifiers each linking to each of one or more posts of the online social network that comprise the URL of the entry of the index;
the counter that records the number of social signals associated with the external object; and
metadata associated with the external object linked in the particular post, the metadata comprising information associated with the external object.

13. The method of claim 12, wherein the index further comprises a local counter that records a number of social signals associated with the URL for the particular post; and
wherein the counter comprises a global counter that determines a total number of social signals associated with the URL for all posts of the one or more posts that comprise the URL corresponding to the URL ID of the entry of the index by calculating a sum of the number of social signals for each of the local counters.

14. The method of claim 13, further comprising:
receiving a new social signal corresponding to a particular post on the online social network;
updating the one or more local counters comprising the URL of the entry of the index; and
updating the global counter based on the updated one or more local counters.

15. The method of claim 1, wherein the counter comprises one or more of:
a first counter that records a total number of comments received for the external object linked in all posts of the one or more posts that comprise the link to the external object;
a second counter that records a total number of reshares for the external object linked in all posts of the one or more posts that comprise the link to the external object;
a third counter that records a total number of likes received for the external object linked in all posts of the one or more posts that comprise the link to the external object;
a fourth counter that records a total number of click-thrus of a link corresponding to the external object linked in all posts of the one or more posts that comprise the link to the external object, the comments, or the reshares linking to the external object; or
any combination thereof.

16. The method of claim 15, wherein when the index comprises a post index, the scoring comprises determining a score for each of the one or more posts by calculating a weighted cumulative total of the first counter, the second counter, the third counter, and the fourth counter, and
wherein the search-results page displays the one or more search results ranked based in part on the score of the identified post.

17. The method of claim 15, wherein when the index comprises a web index, the scoring comprises determining a score for each external object by calculating a weighted cumulative total of the first counter, the second counter, the third counter, and the fourth counter, and
wherein the search-results page displays the one or more search results ranked based in part on the score of each external object.

18. The method of claim 1, wherein the search results of the search-results page are presented in an order based on the scores of the identified posts corresponding to the search results.

19. One or more computer-readable non-transitory storage media embodying software that is operable when executed to:
receive, from a client system of a first user of the online social network, a query to search for posts of the online social network;
search an index to identify one or more posts of the online social network that match the query, each post linking to an external object hosted by a third-party system, wherein the index comprises a counter that records a number of social signals associated with each external object within the online social network;
score each of the identified posts based at least in part on the counter associated with the external object linked to the post; and
send, to the client system of the first user, a search-results page comprising one or more search results, each search result comprising a reference to an identified post having a score greater than a threshold score.

20. A system comprising: one or more processors; and a non-transitory memory coupled to the processors comprising instructions executable by the processors, the processors operable when executing the instructions to:
receive, from a client system of a first user of the online social network, a query to search for posts of the online social network;
search an index to identify one or more posts of the online social network that match the query, each post linking to an external object hosted by a third-party system, wherein the index comprises a counter that records a number of social signals associated with each external object within the online social network;
score each of the identified posts based at least in part on the counter associated with the external object linked to the post; and
send, to the client system of the first user, a search-results page comprising one or more search results, each search result comprising a reference to an identified post having a score greater than a threshold score.
